(19) United States
(12) Patent Application Publication
(10) Pub. No.: US 2015/0066285 A1
(43) Pub. Date: Mar. 5, 2015

(54) MAINTENANCE SUPERVISION SYSTEM FOR A SERIES OF VEHICLES, ASSOCIATED METHOD AND COMPUTER SOFTWARE PROGRAM

(71) Applicant: THALES, Neuilly Sur Seine (FR)

(72) Inventors: Christian ALBOUY, Ville-Mur-Sur-Tarn (FR); Julien Theodore, Toulouse Cedex 1 (FR); Stephane Bertheau, Toulouse Cedex 1 (FR)

(21) Appl. No.: 14/470,176

(22) Filed: Aug. 27, 2014

(30) Foreign Application Priority Data
Aug. 29, 2013 (FR) FR1302006

(51) Int. Cl. G07C 5/00

(52) U.S. Cl. CPC G07C 5/006; G07C 5/008
USPC 701/29.3

(57) ABSTRACT

A maintenance supervision system (1) for supervising maintenance of a series of vehicles, including various devices and equipment units, the system being capable of: collecting data identifying equipment failures; determining maintenance operations to be carried out on each vehicle, based on the data collected; calculating a respective target date for executing each maintenance operation based on a deadline date for putting the vehicle back into operational service; storing in the data base a correlation between each vehicle, the deadline date for putting the vehicle back into operational service, each equipment failure of the vehicle, each maintenance operation determined based on the said equipment failure associated with the target date calculated; issuing a command for the displaying of representations of the said maintenance operations determined for at least one vehicle, that are staggered according to the respective target dates.

This claims the benefit of French Patent Application FR13 02006, filed Aug. 29, 2013 and hereby incorporated by reference herein.

The present invention relates to the field of maintenance of a series of vehicle(s), each vehicle comprising various devices and equipment units.

### BACKGROUND

The series of vehicle(s) comprises, for example, a fleet of aircraft.

The aircraft are complex systems that include a number of equipment units. When in flight or on the ground, the equipment units of the aircraft are subject to failures, which result in the transmission, by the devices and equipment units or systems for monitoring the operation of the aircraft, of failure codes identifying a failure or failures and/or which give rise to alarms sent to the cockpit of the aircraft.

These codes and alarms are then analyzed by maintenance operators. Based on these analyses, maintenance operations are carried out in order to ensure that the aircraft is able to return to a fully operational functioning state.

Given the number of devices and equipment units in an aircraft and the significant volume of failure codes or alarms, it proves to be difficult to synthesize and correlate the amount of information available on the state of operation of the aircraft, with the failures that have occurred and the relevant maintenance operations, as well as to plan, manage and supervise the required maintenance operations in the most suitable manner possible.

### SUMMARY OF THE INVENTION

It is an object of the present invention to provide a maintenance supervision system for supervising maintenance of a series of vehicle(s), characterized in that it includes a data base and is adapted for collecting data identifying equipment failures, in order to determine a set of maintenance operations to be carried out on each vehicle in the series, based on the data collected relative to the vehicle,

the said system being capable of calculating a respective target date for executing each of the said maintenance operations based on a deadline date for putting the vehicle back into operational service,

the said system being capable of storing in the data base a correlation between each vehicle, the deadline date for putting the vehicle back into operational service, each equipment failure of the vehicle, each maintenance operation determined based on the said equipment failure associated with the target date calculated for the said maintenance operation,

the said system being further capable of issuing a command for the displaying on a display screen, of representations of the said maintenance operations determined for at least one vehicle, that are staggered according to the respective target dates.

Such a maintenance supervision system makes it possible to synthesize and to make the linkages between the amount of data and information available regarding the state of the vehicle, the failures that have occurred and the maintenance operations. The various maintenance operations may thus be planned and supervised in the most appropriate manner possible, so as to ensure a coherent and global overview of all the devices and equipment units of the vehicle or vehicles.

Such a system provides the ability to perform timely supervision and the effective distribution of maintenance operations.

The present invention thus provides the ability to increase the level of knowledge and control of maintenance operations on the vehicle or vehicles, and optimizes the speed, rationality and quality of operations thereby ensuring that these vehicles may be returned to their fully operational service state. It also provides the possibility of optimizing the implementation of maintenance operations by technicians.

In the embodiments, the maintenance supervision system for supervising the maintenance of a series of vehicles according to the invention further includes one or more of the following characteristic features:
the system is adapted for collecting the said data identifying equipment failures and the dates of occurrence of the said failures, the said system being capable of issuing a command for the displaying on the said display screen, of representations of the said failures that are staggered according to the respective dates of occurrence of failures;
the system is capable of detecting the selection of a displayed representation of a failure, and in response to the said selection, of selectively displaying the maintenance operation or operations stored in the data base in correlation with the said failure represented;
the system is capable of detecting the selection of a displayed representation of a maintenance operation, and in response to the said selection, of selectively displaying the failure or failures stored in the data base in correlation with the said maintenance operation represented;
the system is in addition capable of:
issuing a command for the displaying on a display screen, simultaneously, of representations of the said maintenance operations determined for a plurality of vehicles in the series, that are staggered according to the respective target dates; and/or
detecting the selection of one element from amongst a temporal zone, an identification of a movement or a phase of movement of a vehicle, a device or equipment type, a type of maintenance operation, a type of failure, and, in response to the said selection detected, of issuing a command for the displaying on a display screen, of representations of the said maintenance operations determined for at least one vehicle, that are staggered according to the respective target dates and filtered according to the said selected element;
the system is capable of calculating the said respective target dates for executing each of the said maintenance operations, in addition, based on at least one element from amongst: an estimated duration for the said maintenance operation or for another maintenance operation to be carried out, a period of availability of the vehicle for the implementation of maintenance operations, time related data indicating the availability of resources needed for the implementation of the maintenance operation;
the target date calculated for a maintenance operation is the latest possible date for the execution of the said operation that will allow for a date for putting the vehicle back into operational service by that deadline date.

According to a second aspect, the present invention provides a maintenance supervision method for supervising the maintenance of a series of vehicle(s), each vehicle comprising devices and equipment units, the method being implemented by computer, and being characterized in that it includes the following steps:
collection of data identifying equipment failures,
determination of a set of maintenance operations to be carried out on each vehicle in the series, based on the data collected relating to the vehicle,
calculation of a respective target date for each of the said maintenance operations based on a deadline date for putting the vehicle back into operational service,
storage in a data base of a correlation between each vehicle, the deadline date for putting the vehicle back into operational service, each equipment failure of the vehicle, each maintenance operation determined based on the said equipment failure associated with the target date calculated for the said maintenance operation,
issuing a command for the displaying on a display screen, of representations of the said maintenance operations determined for at least one vehicle, that are staggered according to the respective target dates.

According to a third aspect, the present invention provides a computer software program to be installed in a maintenance supervision system for a series of vehicles each including devices and equipment units, the said software program comprising instructions for implementation of the steps of such a method according to the first aspect of the invention, during the execution of the program by the data processing means of the said maintenance supervision system.

### BRIEF DESCRIPTION OF THE DRAWINGS

These characteristic features and advantages of the invention shall become apparent upon reviewing the description that will follow, provided solely by way of example, and with reference made to the accompanying drawings, in which:

FIG. 1 shows a maintenance supervision system for a series of vehicles in one embodiment of the invention;

FIG. 2 shows the steps of a method in an embodiment of the invention; and

FIG. 3 shows a view of a display screen in an embodiment of the invention.

### DETAILED DESCRIPTION

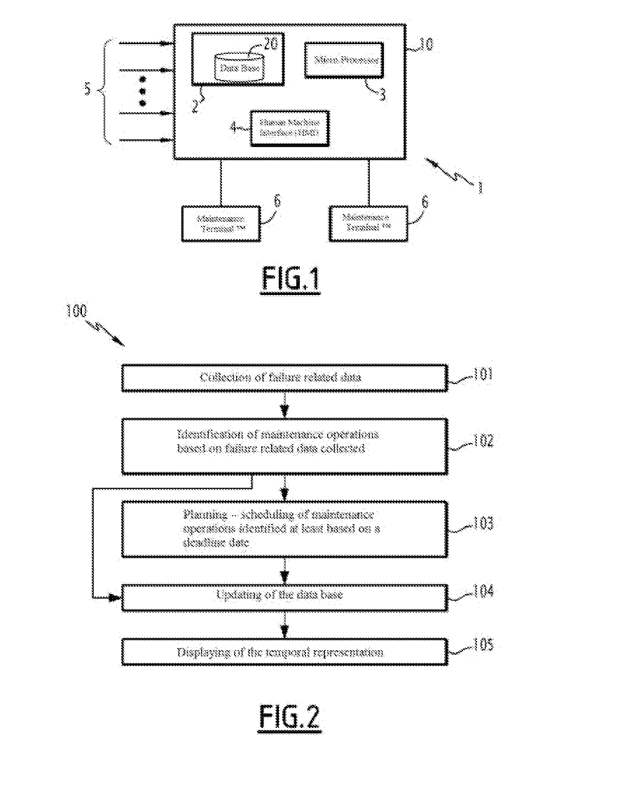

In FIG. 1, a maintenance supervision system 1 for supervising maintenance of a fleet of aircraft is represented in one embodiment of the invention.

The fleet of aircraft includes a number N of aircraft (N may take any value greater than or equal to 1).

Each aircraft includes devices and equipment units that are diverse in nature and function: devices and equipment units for propulsion systems, combat, supervision, etc.

The maintenance supervision system 1, hereinafter referred to as supervision system 1, includes a device for data processing 10, a memory 2 containing a data base 20, a small micro programming unit 3 and a human-machine interface (HMI) 4. In the embodiment considered, the supervision system 1 further includes a maintenance terminal or terminals 6, for example, remote terminals, with each having an HMI and connected to the data processing device 10 by means of a wired or wireless connection, for example WiFi, Bluetooth, etc. In one embodiment, at least one maintenance terminal 6 is disposed in the facilities where maintenance crews are stationed.

In one embodiment, the HMI units of the data processing device 10 and maintenance terminals 6 comprise the means for display and the means for inputting commands of users of these HMI, in this present case, these display and input means comprise of a touch screen.

A software instructions program P is stored in the memory 2 of the data processing device 10, which upon being executed by the microprocessor 3 is capable of implementing the steps indicated here below with reference made to FIG. 2.

In the present embodiment considered, the data processing device 10 is capable of collecting and/or storing a set 5 of data.

In the embodiment considered, this set 5 of data collected includes data representative of the state of operation and/or malfunctioning of each of the aircraft, thereby enabling the identification of failures/malfunctions of the aircraft and the equipment unit involved in each failure, and indicating the dates of occurrence of failures. Included amongst the data and information are the codes for equipment failures, alarms, the data relating to functional/software/hardware configuration, test results, and the calibration results. Some of these data may be transmitted on a constantly updated basis in real time, by the aircraft in flight or on the ground, or on the contrary, they may be transmitted, for example by downloading from the aircraft or from a device that is in permanent or temporary connection with the aircraft, for example a testing tool. Hereinafter the term “failure related data” will be used to refer to the data indicating the failures. The data processing device 10 is capable of storing the failure related data, identifying the failures and respectively indicating the corresponding dates of occurrence of these failures, collected for an aircraft in the data base 20 in correlation with an identifier for the aircraft, and as may be appropriate in correlation with an identifier for the aircraft equipment unit related to the failure.

In the embodiment as considered, the set 5 of data collected includes in addition the data that define and/or update the activity of each of the aircraft, for example, for each aircraft:
data related to the current flight plan comprising the flight dates, phases of flight (takeoff, landing, etc), positions, altitudes, speeds and/or directions associated therewith;
data establishing the latest possible date for putting the aircraft back into fully operational service: in a known manner, a list of minimum equipment items, known as MEL (acronym for “Minimum Equipment List”), is associated with each aircraft as well as a regulatory deadline date, hereinafter referred to as “MEL date”, after which the aircraft would no longer be permitted to take off again in the event of there remaining as on that date a persistent malfunction affecting any equipment item included in the MEL (the aircraft may nevertheless be permitted to fly with this malfunction prior to this deadline date);
schedule of the aircraft: scheduled date for planned maintenance, dates/periods of unavailability for the flight (or availability for a phase of maintenance), date of subsequent flight assignment(s).

Hereinafter these data shall be referred to as “aircraft activity data”. The data processing device 10 is capable of storing the aircraft activity data collected and relating to an aircraft in the data base 20 in correlation with an identifier for the aircraft.

In the present embodiment considered, the set 5 of data collected moreover also includes theoretical data relating to the maintenance of the aircraft, for example:

information that determines, based on the failure related data, the type of maintenance operation(s) to be carried out, and the equipment unit or units on which the maintenance operation is to be carried out;

operational reliability criteria, for example in the form of the mean time elapsing between failures (values known as “MTBF” for the term “Mean Time Between Failures”) for equipment units of the aircraft;

data for determining the warranty on the equipment units, standard costs, standard lead times and/or specific location of intervention according to the types of maintenance operation, data concerning organization and policy related to maintenance (logistics, spare parts, imposed subcontracting, professional qualifications necessary for technicians working in maintenance functions as appropriate to the equipment items, repair lead times, etc).

Hereinafter these data shall be referred to as “data for determination of required maintenance”. The data processing device 10 is capable of storing the data for determination of required maintenance in the data base 20. It is to be noted that these data may be collected, in particular according to the needs, from the servers that make them available. In another embodiment, from the moment of the data processing device 10 being placed in operation, the data are stored in the data base 20, with the items for the updating of the data being subsequently collected by the data processing device 10 upon their being made available.

In addition to these data collected, the data base 20 provides information pertaining to maintenance supervision relative to the maintenance operations planned for the aircraft: for each of the planned maintenance operations, an identifier for a type of maintenance operation, a scheduled intervention date, the identifiers for the concerned equipment units and aircraft involved in this intervention and the failure related data that were originally responsible for bringing about this maintenance operation are correlated in the data base 20, thanks to the implementation of the steps detailed here below.

In one embodiment, the data processing device 10 according to the invention is capable of setting in motion the series of steps 100 described here below.

In the step 101, the data processing device 10 collects data for the data set 5 described here above and stores the said data collected in the data base 20. This phase of data collection or at least the collection of some of these data takes place in real time.

In the step 102, that is for example implemented at each time step Tᵢ (Tᵢ=T0+iT, where i is an integer and T is for example equal to 1 minute), the data processing device 10 sequentially considers the failure related data collected between Tᵢ₋₁ and Tᵢ. On the basis of each of these failure related data items considered successively, the data processing device 10 determines the aircraft identified by the latter, and where applicable one or more equipment units of the aircraft affected. It then determines, based on the failure related data considered successively and in addition to the data for determination of required maintenance, the type of maintenance operations to be carried out and, where applicable, the equipment unit or units on which each of these maintenance operations are to be carried out for the aircraft identified.

For each of these maintenance operations determined for each aircraft, the data processing device 10 ascertains, from the maintenance supervision related information that relates to the aircraft and is stored in the data base 20, whether it has already been scheduled for that aircraft.

In the affirmative case, in the step 104, the data processing device 10 further enhances the maintenance supervision related information stored by ensuring in addition, the correlation in the data base 20, of this already planned and scheduled maintenance operation with the considered failure related data collected between Tᵢ₋₁ and Tᵢ. And then it considers the subsequent failure related data.

In the negative case, in the step 103, the data processing device 10 determines a target date for execution for each of the maintenance operations determined and not already scheduled. In one embodiment, this target date is determined by taking into account the constraint according to which the maintenance operation in question is to be completed prior to the MEL date.

For example, in order to determine the target date for such a maintenance operation, the data processing device 10 calculates the result of a function F. The result of the function F is a target date equal to the latest possible start date for commencing the maintenance operation that allows for the completion of the maintenance operation prior to the MEL date specified in the data base 20 for the aircraft involved in the maintenance operation.

The function F has as input variables the type of maintenance operation, the identifier for the aircraft involved and where appropriate the identifier for the concerned equipment unit(s) in the aircraft.

The result of the function F is calculated based on data stored in the data base 20, in particular the MEL date specified for the aircraft.

In one embodiment, the result of the function F is calculated in addition, on the basis of at least some of the aircraft activity data stored in the data base 20 in correlation with the aircraft (in fact, it is necessary for the maintenance operation to take place during a period when the aircraft is available for this, that is, in particular outside of flight periods, etc.), and/or at least some of the data for determination of required maintenance (in particular the standard intervention lead time necessary for this maintenance operation, the need for subcontracting and therefore data concerning availability of the subcontractor to be collected; in the event of a material resource, such as a spare part being needed, the result of the function F takes into account a time period for acquiring a supply of the spare part, this period being obtained for example by the data processing device 10 sending a request to a relevant server), etc.

In one embodiment, the function F makes use of data related to planning—scheduling of maintenance—, human—, and/or material resources such as particular facilities/personnel necessary for some of the operations (for example, it requires the downloading in advance, of this data by the data processing device 10 from a server and the result thereof is calculated based on these data related to planning—scheduling of maintenance resources).

In another embodiment, only the target dates determined for the maintenance operations affecting the equipment units included in the MEL list take into account the constraint according to which the maintenance operation in question is to be completed prior to the MEL date.

In the step 104, the data base 20 is updated by the data processing device 10 for these newly planned maintenance operations, by storing them in the data base and by ensuring the correlation in the data base 20, of each of these maintenance operations, with an identifier for the type of maintenance operation, the calculated target date, the identifiers for the aircraft and, where appropriate, for the concerned equipment units involved in the operation, and the failure related data based on which, during the step 102, the determination of this maintenance operation has taken place.

In the step 105, the data processing device 10 sends a command for the refreshing of the display appearing on the display screen of the HMI 4 of the data processing device 10 based on the data base 20 being updated in the step 104 and depending on the type of view then selected by the user of the HMI 4.

In the present case under consideration where the supervision system 1 in addition includes maintenance terminals 6, the data processing device 10 further sends a command for the refreshing of the display appearing on the display screen of the HMI of each maintenance terminal 6 based on the data base 20 being updated in the step 104 and depending on the type of view then selected by the user of this maintenance terminal 6.

Then the process 100 is repeated for the subsequent time step Tᵢ₊₁.

The types of views accessible from the HMI 4 or from the HMI of the maintenance devices 6 are described farther below.

In one embodiment, the screen view displayed upon the switching on of the HMI 4 or the HMI of the maintenance terminals 6 as per the command from the data processing device 10, includes the fields in which the user is asked to enter a user name and a password in order to be given access, following the operations of identification and authentication based on the username and password entered, to a Home page menu providing access to at least some of the functionalities and features offered on the menu.

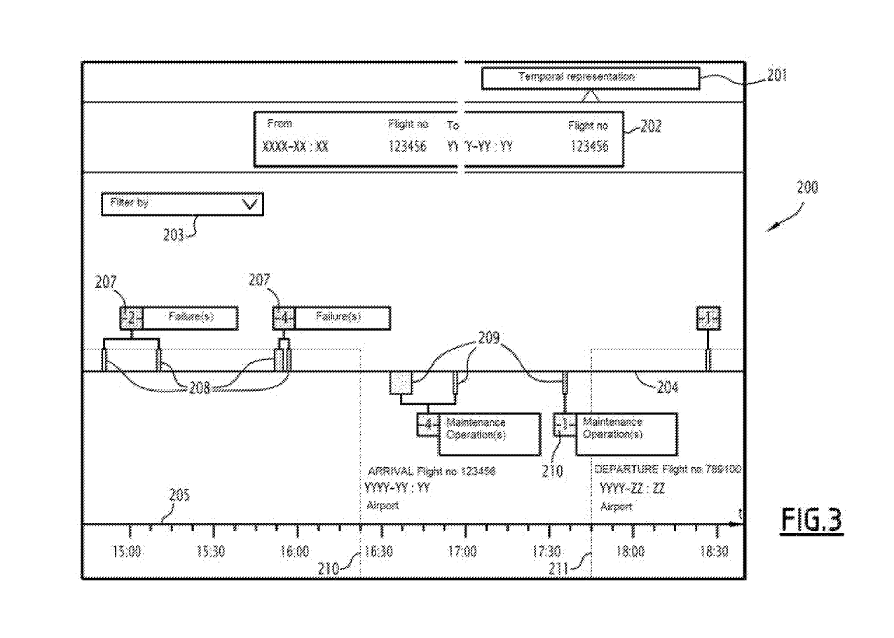

A display 200 on an HMI screen (HMI 4 or HMI of a maintenance terminal 6) in accordance with a view selected by the user of the HMI in one embodiment is represented in FIG. 3.

This display 200 includes:

a drop down submenu 201 offering the following choices: “temporal representation”, “statistics”; in this case, the user has selected “temporal representation”;

an aircraft identification field 202; in the present case considered the aircraft is identified by the flight number, 123456 here, of the flight completed by the aircraft, the identifier for the airport of departure of the flight and the date and time of departure (field “From XXXX-XX:XX”), the identifier for the airport of arrival of the flight and the date and time of arrival (field “To YYYY-YY:YY”);

a drop down field for filters 203 offering to filter the display of failures and maintenance operations listed on the time line 204 on the basis of: a type of equipment of the aircraft, a type of failure, a type of maintenance operation, a time period related to the maintenance operations and/or to the failures, a flight phase, and/or a flight selected by the user; in this case, there are no filters selected.

Based on the choice “temporal representation” in the submenu 201, the data processing device 10 has issued a command for displaying a time line 204. The time at each point in the time line 204 is indicated by the time shown on the scale 205 at the vertical point.

The moment corresponding to the arrival time of the flight 123456 executed by the aircraft is indicated by a vertical dashed line 210, while the moment corresponding to the departure time of the subsequent flight (No. 789100) executed by the aircraft is indicated by a vertical dashed line 211.

The time line 204 has vertical lines arranged along the time line 204, some above the time line 204 and others below the time line 204.

The rectangles 208 positioned on the time line 204 above the time line represent the equipment failures identified by the failure related data stored in the data base 20. The number displayed within a field 207 connected to one or more rectangles 208 indicates the number of distinct failures corresponding to the set of rectangles 208 so connected. The left side of a rectangle 208 on the time line 204 indicates the time of occurrence of the first failure related data collected for the failures enumerated in the connected field 207 (its value is the time shown on the scale 205 at the vertical of the left side) as contained in the data base 20. The width of a rectangle 208 indicates the volume of failure related data collected corresponding to these failures enumerated in the connected field 207, over a period of time that may be configured based on the time of occurrence of the first failure related data for the failures under consideration.

The rectangles 209 positioned on the time line 204 below the time line 204 represent the planned and scheduled maintenance operations. The position of the left side of a rectangle 209 on the time line indicates the start time of planning (or execution) of the maintenance operation and the position of the right side of a rectangle 209 on the time line indicates the end time of planning/execution of the maintenance operation (the precise value is indicated in particular by the time shown on the scale 205 at the vertical of the side considered) as contained in the data base 20. The number displayed within a field 210 connected to one or more rectangles 209 indicates the number of maintenance operations corresponding to the set of connected rectangles 209. The criteria for grouping of operations within the same field 210 may be configured: for example, in one embodiment it involves those included in the same interval of repair and/or taken care of by the same maintenance operator and/or within a same given facility and/or relating to a same predefined set of equipment units, etc.

The content and positioning of these representations of failures and maintenance operations on the screen view 200 are determined by the data processing device 10 in accordance with the corresponding data stored in the data base 20 for the aircraft selected in the field 202, in particular the position of the line for a maintenance operation, with respect to a failure, is that corresponding to the target date calculated for this maintenance operation of the aircraft, respectively on the date of occurrence of the failure. And the command for the display thereof is issued by the data processing device 10.

If the user of the HMI considered selects one of the fields 207 indicating a number n of failures, by touch pressing the key on the screen on this field, the data processing device 10 sends a command for the displaying on this HMI, in superposition over the view currently displayed, of the list of identifiers of n failures recorded in the data base 20 as on the date or dates corresponding to the field 207 selected. If the user then selects one of these n failures, the data processing device 10 sends a command for the displaying of a frame including the failure related data corresponding to the selected failure and the identifier for the maintenance operation or maintenance operations stored in correlation with these failure related data in the data base 20.

Similarly, if the user of the HMI considered selects a field 210 indicating a number p of maintenance operations, by pressing a key on the screen on this field 210, the data processing device 10 sends a command for the displaying on this HMI, in superposition over the view currently displayed, of the list of identifiers of p maintenance operations. If the user then selects one of these p maintenance operations, the data processing device 10 then sends a command for the displaying of a frame including the identifier for the maintenance operation selected and the failure related data stored in correlation with the identifier for the maintenance operation selected in the data base 20.

In the present embodiment considered with reference to the screen view 200, the user has selected to view in superposition the flight data indicating the arrival and departure of the selected flight.

In the present embodiment considered, the user may move over the time line by pressing on the screen on the time line 204 and executing a movement on the screen from left to right (in order to go back in time) or from right to left (in order to go forward in time). The HMI detects the command, transmits it to the data processing device 10, which in response, changes the view displayed by displaying the new time zone as per the command thus sent.

In one embodiment, a sub-menu (not shown in FIG. 3) offers the user the ability to select the time scale or the level of gradation of the time line, with the data processing device 10 adapting the display in accordance with the selection made by the user.

In one embodiment, the user selects from the drop down box of filters 203, one or more of the said filters that are offered therein. The HMI transmits it to the data processing device 10, which then sends a command for the displaying of the failures and/or the maintenance operations restricted to the filtered items. For example, if the user selects a particular flight phase, only the failures that occurred during this flight phase and the maintenance operations that are correlated to these failure related data will be displayed on the time line 204.

In one embodiment, the user selects the display of a temporal representation of failures and maintenance operations on a fleet of aircraft, by selecting the identifier for the fleet in the zone 202. Following this command, the data processing device 10 sends a command for the displaying on the time line of all the failures and maintenance operations associated with the series of aircraft in the fleet selected in the data base 20 (in such a case, the data base 20 further stores each fleet identifier in correlation with all of the identifiers for the aircraft in the fleet thus identified).

In one embodiment the user of a maintenance terminal 6 may after identification and authentication, enter information via the HMI of the maintenance terminal, relating to a planned maintenance operation scheduled for an aircraft, relative to the test operation results, calibration etc., or relative to a change in the planning—scheduling of the maintenance operation. The data processing device then stores these data and information in the data base 20, in correlation with this maintenance operation.

In one embodiment, the user selects the “statistics” field in the sub menu 201. Upon receiving this command, the data processing device 10 is capable of calculating various statistics based on the content of the data base 20, in relation to the aircraft, to all of the aircraft in a fleet, or even to each or some of the equipment units: for example the failure rate of a device or equipment unit of an aircraft, the failure rate of an equipment unit, taking into account all of the aircraft that have this equipment unit, the maintenance operation rate per equipment unit or per type of equipment, the time spent for restoring an equipment unit of an aircraft to its operational state etc.

A maintenance supervision system according to the invention thus ensures the ability to provide in an automated manner, the staggering or phasing over time of maintenance operations and failures, and to provide appropriate screen views that make it possible to correlate the failures and the maintenance operations corresponding to these failures. These elements make it possible to optimise the overall time period required for the maintenance operations while ensuring compliance with the MEL dates in particular.

In the embodiment described with reference to the figures, it was considered that the invention had been applied to aircraft. The invention may be implemented for any type of vehicle including devices and equipment units that are subject to failures.

What is claimed is:

1. A maintenance supervision system for supervising maintenance of a series of vehicles, each vehicle comprising equipment units, the system comprising:
a data base and being adapted for collecting data identifying equipment failures, for determining a set of maintenance operations to be carried out on each vehicle in the series, based on the data collected relative to the vehicle, the system being capable of calculating a respective target date for executing each of the maintenance operations based on a deadline date for putting the vehicle back into operational service, the system being capable of storing in the data base a correlation between each vehicle, the deadline date for putting the vehicle back into operational service, each equipment failure of the vehicle, each maintenance operation determined based on the said equipment failure associated with the target date calculated for the maintenance operation, the system being further capable of issuing a command for the displaying on a display screen representations of the maintenance operations determined for at least one vehicle, that are staggered according to the respective target dates.

2. The maintenance supervision system for a series of vehicles as recited in claim 1 adapted for collecting the data identifying equipment failures and the dates of occurrence of the failures, the system being capable of issuing a command for the displaying on the said display screen, of representations of the said failures that are staggered according to the respective dates of occurrence of failures.

3. The maintenance supervision system for a series of vehicles as recited in claim 2 capable of detecting the selection of a displayed representation of a failure, and in response to the said selection, of selectively displaying the maintenance operation or operations stored in the data base in correlation with the said failure represented.

4. The maintenance supervision system for a series of vehicles as recited in claim 1 capable of detecting the selection of a displayed representation of a maintenance operation, and in response to the said selection, of selectively displaying the failure or failures stored in the data base in correlation with the said maintenance operation represented.

5. The maintenance supervision system for a series of vehicles as recited in claim 1 the said system being in addition capable of:
issuing a command for the displaying on a display screen, simultaneously, of representations of the maintenance operations determined for a plurality of vehicles in the series, that are staggered according to the respective target dates; and/or
detecting the selection of one element from amongst a temporal zone, an identification of a movement or a phase of movement of a vehicle, a device or equipment type, a type of maintenance operation, a type of failure, and, in response to the said selection detected, of issuing a command for the displaying on a display screen, of representations of the said maintenance operations determined for at least one vehicle, that are staggered according to the respective target dates and filtered according to the selected element.

6. The maintenance supervision system for a series of vehicles as recited in claim 1 capable of calculating the said respective target dates for executing each of the said maintenance operations, in addition, based on at least one element from amongst: an estimated duration for the said maintenance operation or for another maintenance operation to be carried out, a period of availability of the vehicle for the implementation of maintenance operations, time related data indicating the availability of resources needed for the implementation of the maintenance operation.

7. The maintenance supervision system for a series of vehicles as recited in claim 1 wherein the target date calculated for a maintenance operation is the latest possible date for the execution of the said operation that will allow for a date for putting the vehicle back into operational service by that deadline date.

8. A maintenance supervision method for supervising the maintenance of a series of vehicles, each vehicle comprising equipment units, the said method being implemented by computer, said method including the following steps:
collecting data identifying equipment failures;
determining a set of maintenance operations to be carried out on each vehicle in the series, based on the data collected relating to the vehicle;
calculating a respective target date for each of the maintenance operations based on a deadline date for putting the vehicle back into operational service;
storing in a data base of a correlation between each vehicle, the deadline date for putting the vehicle back into operational service, each equipment failure of the vehicle, each maintenance operation determined based on the equipment failure associated with the target date calculated for the said maintenance operation; and
issuing a command for the displaying on a display screen, of representations of the said maintenance operations determined for at least one vehicle, that are staggered according to the respective target dates.

9. The maintenance supervision method for a series of vehicles as recited in claim 8 further comprising:
collecting the data identifying equipment failures and the dates of occurrence of the said failures, and
issuing the command for the displaying on the display screen, of representations of the maintenance operations that are staggered according to the dates of occurrence of the said failures.

10. The maintenance supervision method for a series of vehicles as recited in claim 9 further comprising:
detecting the selection of a displayed representation of a failure, and
in response to the said selection, selectively displaying the maintenance operation or operations stored in the data base in correlation with the said failure represented.

11. The maintenance supervision method for a series of vehicles as recited in claim 8 further comprising:
detecting the selection of a displayed representation of a maintenance operation, and
in response to the selection, selectively displaying the failure or failures stored in the data base in correlation with the maintenance operation represented.

12. The maintenance supervision method for a series of vehicles as recited in claim 8 further comprising the steps of:
issuing a command for the displaying on a display screen, simultaneously, of representations of the said maintenance operations determined for a plurality of vehicles in the series that are staggered according to the respective target dates; and/or
detecting the selection of one element from amongst a temporal zone, an identification of a movement or a phase of movement of a vehicle, a device or equipment type, a type of maintenance operation, a type of failure, and, in response to the selection detected, issuing a command for the displaying on a display screen, of representations of the said maintenance operations determined for at least one vehicle, that are staggered according to the respective target dates and filtered according to the selected element.

13. The maintenance supervision method for a series of vehicles as recited in claim 8 further comprising the steps of:
calculating the said respective target dates for executing each of the said maintenance operations, in addition, based on at least one element from amongst: an estimated duration for the said maintenance operation or for another maintenance operation to be carried out, a period of availability of the vehicle for the implementation of maintenance operations, time related data indicating the availability of resources needed for the implementation of the maintenance operation.

14. The maintenance supervision method for a series of vehicles as recited in claim 8 wherein the target date calculated for a maintenance operation is the latest possible date for the execution of the said operation that will allow for a date for putting the vehicle back into operational service by the said deadline date.

15. A computer software program to be installed in a maintenance supervision system for a series of vehicle each including equipment units, the software program comprising instructions for implementation of the following steps during the execution of the program by the data processor of the maintenance supervision system:
collecting data identifying equipment failures,
determining a set of maintenance operations to be carried out on each vehicle in the series, based on the data collected relating to the vehicle,
calculating a respective target date for each of the said maintenance operations based on a deadline date for putting the vehicle back into operational service,
storing in a data base of a correlation between each vehicle, the deadline date for putting the vehicle back into operational service, each equipment failure of the vehicle, each maintenance operation determined based on the said equipment failure associated with the target date calculated for the said maintenance operation, and
issuing a command for the displaying on a display screen, of representations of the said maintenance operations determined for at least one vehicle, that are staggered according to the respective target dates.
